(19) United States
(12) Patent Application Publication
(10) Pub. No.: US 2005/0253729 A1
(43) Pub. Date: Nov. 17, 2005

(54) Laser pointing device having thermal detection function

(76) Inventor: Shen-Ping Su, Chung Li City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/842,539

(22) Filed: May 11, 2004

(51) Int. Cl. G08B 17/00

(52) U.S. Cl. 340/584

(57) ABSTRACT

A laser pointing device having a thermal detection function is applied in a garage to guide a driver to park a car. The laser pointing device has a thermal detector, a laser diode, and a drive module. The thermal detector is used to detect the temperature of the ambient environment. The drive module is electrically connected between the thermal detector and the laser diode. When the thermal detector detects that the temperature of the ambient environment exceeds a threshold temperature, the drive module will drive the laser diode to emit a laser light beam. Thereby, when a driver parks his car in a garage, the laser light beam will be emitted to guide him to park the car after the thermal detector detects that the temperature of the car's engine exceeds the threshold temperature.

### FIELD OF THE INVENTION

The present invention relates to a laser pointing device having a thermal detection function and, more particularly, to a laser pointing device applied in a garage for guiding a driver to park a car.

### BACKGROUND OF THE INVENTION

Along with quick development of the global economy, cars have become the primary means of transportation in the lives of many people today. In many countries, a common family can afford to buy a car.

In order to meet the parking requirement of people, a residence house generally has a garage for parking car. However, for enhancing the usage of space, the garage is also used as a storeroom, hence reducing the space for parking the car. During the parking process, a driver needs to be very careful to avoid touching other objects in the garage due to the limit of his field of vision.

Accordingly, the present invention aims to propose a laser pointing device having a thermal detection function to solve the above problem in the prior art.

### SUMMARY AND OBJECTS OF THE PRESENT INVENTION

The primary object of the present invention is to provide a laser pointing device having a thermal detection function, which can emit a laser light beam for guiding a driver to park successfully a car in a garage and avoid touching other objects in the garage with the car.

To achieve the above object, the present invention provides a laser pointing device having a thermal detection function, which comprises a thermal detector, a laser diode, and a drive module. The thermal detector is used to detect the temperature of the ambient environment. The drive module is electrically connected to the thermal detector and the laser diode. When the thermal detector detects that the temperature of the ambient environment exceeds a threshold temperature, the drive module will drive the laser diode to emit a laser light beam. Thereby, when a driver parks a car in a garage, the thermal detector can automatically detect the car’s temperature and the laser diode will emit a laser light beam to guide him to park the car successfully.

### BRIEF DESCRIPTION OF DRAWING

The various objects and advantages of the present invention will be more readily understood from the following detailed description when read in conjunction with the appended drawings, in which:

FIG. 1 is a perspective view of a laser pointing device of the present invention;

FIG. 2 is a circuit wiring diagram of a laser pointing device of the present invention;

FIG. 3 is a circuit block diagram of a laser pointing device of the present invention; and

FIG. 4 is a plan view of a laser pointing device of the present invention applied in a garage.

### DETAILED DESCRIPTION OF PREFERRED EMBODIMENT

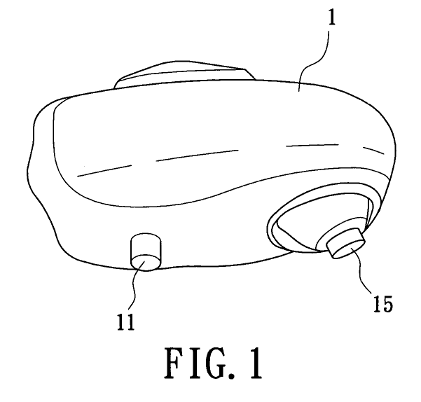

As shown in FIG. 1, a laser pointing device 1 having a thermal detection function of the present invention comprises a thermal detector 11 and a laser diode 15. The thermal detector 11 is used to detect the temperature of the ambient environment to determine whether the temperature of the ambient environment exceeds a threshold temperature for conduction of the thermal detector. If the temperature of the ambient environment exceeds the threshold value, the laser diode 15 will emit a laser light beam for guiding. The thermal detector 11 used is an infrared sensor, which can detect the temperature within the range covered a certain distance (preferably about 6 m) and angle (preferably about 150 degrees).

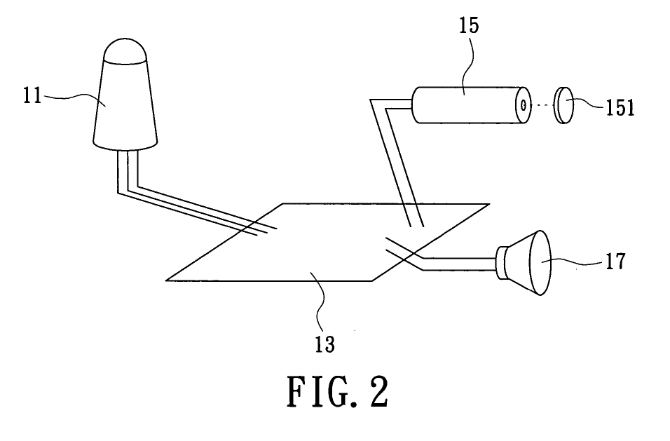

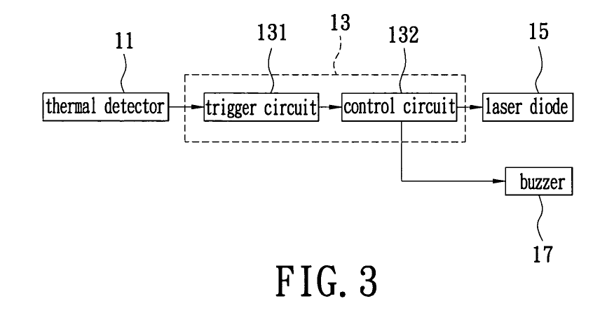

Reference is made to FIGS. 2 and 3 simultaneously. A drive module 13 is connected to the output end of the thermal detector 11, the input end of the laser diode 15, and the input end of a buzzer 17. The drive module 13 further comprises a trigger circuit 131 and a control circuit 132. The trigger circuit 131 is used to receive a conduction signal (generated when the thermal detector detects that the temperature of the ambient environment exceeds the threshold value) output by the thermal detector 11 and then output an enable signal to the control circuit 132. The control circuit 132 will control the laser diode 15 to emit a laser light beam and the buzzer 17 to generate buzzing sounds when the thermal detector 11 is conducted on, thereby accomplishing both visual and aural warning.

Besides, a diffraction lens 151 can be provided at the emission opening of the laser diode 15. The shape of the diffraction lens 151 can be an arbitrary text or pattern to produce a light beam having a specific text or pattern shape after the laser light beam emitted by the laser diode 15 passes through the diffraction lens 151. This light beam of a specific shape can provide a stronger warning. The laser pointing device of the present invention can respond to the temperature of the ambient environment to produce both visual and aural warnings. The condition is that the temperature in the range detectible by the thermal detector 11 exceeds the threshold value.

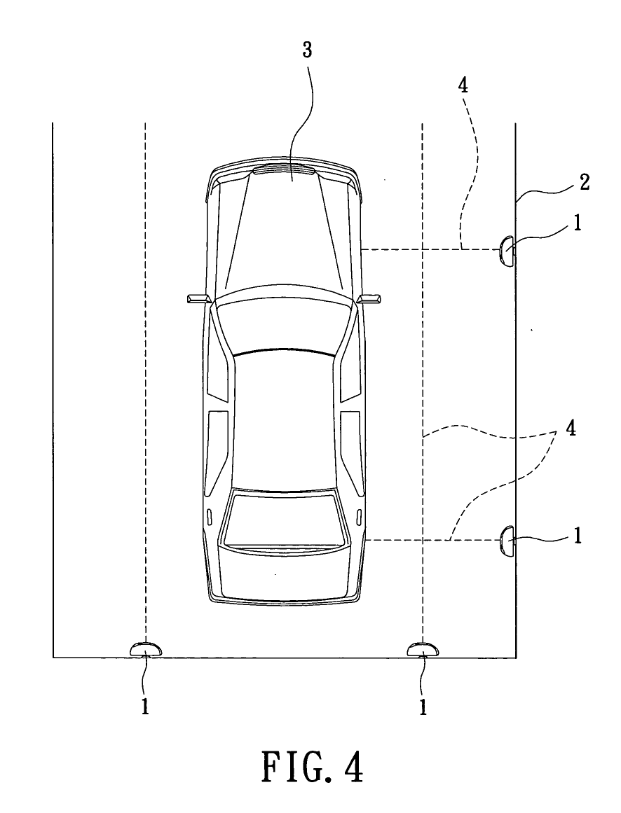

The laser pointing device 1 of the present invention can be applied in a garage. The emitted laser light beams are used to define a safe parking area. As shown in FIG. 4, two laser pointing devices 1 are installed at the back of a garage to guide a diver to park a car between these two laser pointing devices 1. Two laser pointing devices 1 can also be installed at front and rear positions of the side of the garage for guiding a driver to park the front and rear wheels of a car between these two laser pointing devices.

When a driver wants to park a car 3 into a garage 2, after he drives the car 3 into the range sensible by the laser pointing devices 1, the laser pointing devices 1 will detect the high temperature of the car's engine (exceeding the threshold value for conduction of the thermal detector), and a laser light beam 4 and buzzing sounds will be produced. After the driver hears the buzzing sounds, he can see the region defined out by laser light beams. Therefore, the driver can drive the car 3 into this region without hitting other objects in the garage with the car 3 during the parking process. Of course, the laser pointing devices 1 are arranged at such positions that the emitted laser light beams 4 can be seen by the driver and form a safe parking area.

To sum up, the laser pointing device having a thermal detection function of the present invention has the following characteristics:
1. Laser light beams are automatically produced through detection of the temperature of the ambient environment, hence providing guide indications having a visual effect.

2. A buzzer is also integrated to provide an aural warning.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

1. A laser pointing device having a thermal detection function comprising:
a thermal detector used to detect a temperature of the ambient environment;
a laser diode used to emit a laser light beam; and
a drive module electrically connected to said thermal detector and said laser diode, said drive module driving said laser diode to emit a laser light beam after said thermal detector detects the temperature of the ambient environment exceeding a threshold temperature.

2. The laser pointing device having a thermal detection function as claimed in claim 1, wherein said thermal detector is an infrared detector.

3. The laser pointing device having a thermal detection function as claimed in claim 1, wherein a lens is further provided at an emission opening of said laser diode.

4. The laser pointing device having a thermal detection function as claimed in claim 3, wherein said lens is a diffraction lens.

5. The laser pointing device having a thermal detection function as claimed in claim 4, wherein said diffraction lens has text or picture patterns thereon.

6. The laser pointing device having a thermal detection function as claimed in claim 1, wherein said drive module comprises:
a trigger circuit electrically connected to said thermal detector and used to receive a conduction signal of said thermal detector; and
a control circuit electrically connected to said trigger circuit and used to control the illumination state of said laser diode.

7. The laser pointing device having a thermal detection function as claimed in claim 1 further comprising a buzzer electrically connected to said drive module, said buzzer generating buzzing sounds after said thermal detector detects the temperature of the ambient environment exceeding said threshold temperature.
